(19) United States
(12) Patent Application Publication
(10) Pub. No.: US 2015/0179354 A1
(43) Pub. Date: Jun. 25, 2015

(54) SOLAR CELL AND METHOD FOR MANUFACTURING THE SAME

(71) Applicant: Chiun Mai Communication Systems, Inc., New Taipei (TW)

(72) Inventor: HOW-WEN CHIEN, New Taipei (TW)

(21) Appl. No.: 14/521,967

(22) Filed: Oct. 23, 2014

(30) Foreign Application Priority Data
Dec. 20, 2013 (CN) 201310705805.1

(51) Int. Cl. H01G 9/20; H01G 9/00; H02S 30/20

(52) U.S. Cl. CPC H01G 9/2095; H01G 9/2068; H02S 30/20; H01G 9/0036

(57) ABSTRACT

A flexible solar cell has a flexible transparent substrate and a plurality of solar cell units attached to the flexible transparent substrate. The solar cell units are space from each other, thereby defining light-transmitting areas on the flexible transparent substrate among the solar cell units, allowing light to transmit therethroug. A method for manufacturing the flexible solar cell is also provided.

### FIELD

The present disclosure relates to solar cells and methods for solar cell manufacture.

### BACKGROUND

Solar cells are photoelectric conversion devices. A low light reflectivity and high absorption of the solar cell is needed to achieve an improved photoelectric conversion efficiency. Dye-sensitized solar cells (DSSCs) have been developed, and are produced using low cost material and do not require complex equipment for their manufacture. DSSCs usually use glass as substrate which is very rigid.

### BRIEF DESCRIPTION OF THE DRAWINGS

Implementations of the present technology will now be described, by way of example only, with reference to the attached figures.

FIG. 1 is an isometric view of a solar cell according to an exemplary embodiment.

FIG. 2 is a cross-sectional view of the solar cell of FIG. 1 taken along line II-II.

FIG. 3 is an enlarged view of circled portion IV of FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The term “comprising,” when utilized, means “including, but not necessarily limited to”; it specifically indicates open-ended inclusion or membership in the so-described combination, group, series and the like.

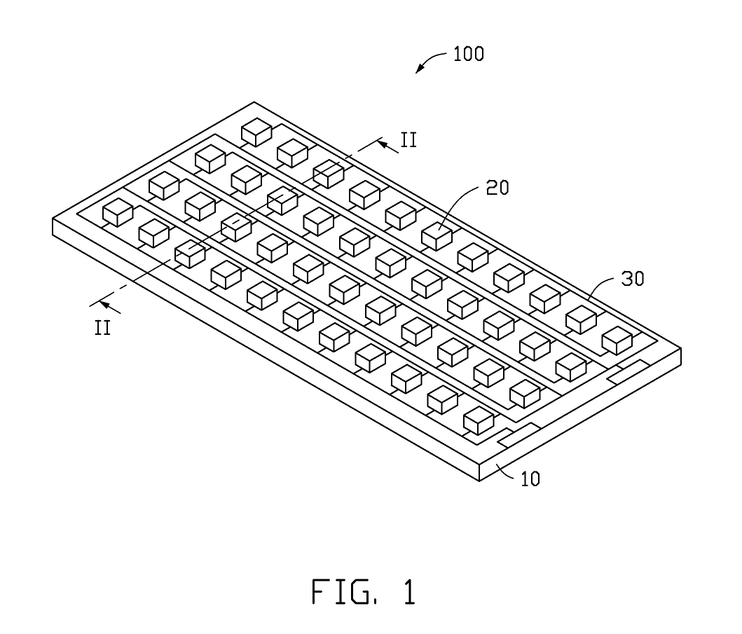

FIG. 1 illustrates that a solar cell 100 according to an exemplary embodiment comprises a flexible transparent substrate 10 and a plurality of solar cell units 20 attached to a surface of the flexible transparent substrate 10 The solar cell units 20 are spaced from each other, thereby defining light-transmitting areas on the flexible transparent substrate 10 among the solar cell units 20, allowing light to transmit therethroug. In one embodiment, the solar cell units 20 are arranged in an array.

The flexible transparent substrate 10 is transparent and flexible and can be made of plastic or glass. The plastic comprises polyethylene terephthalate (PET) and polyimide (PI) material.

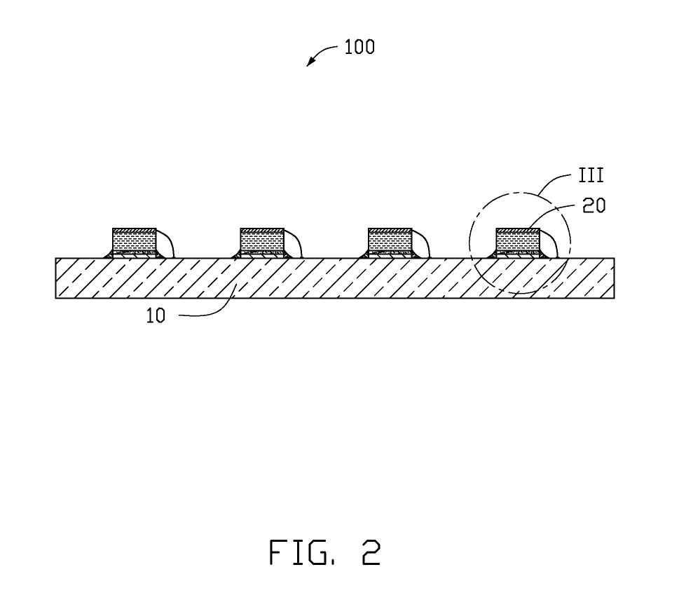

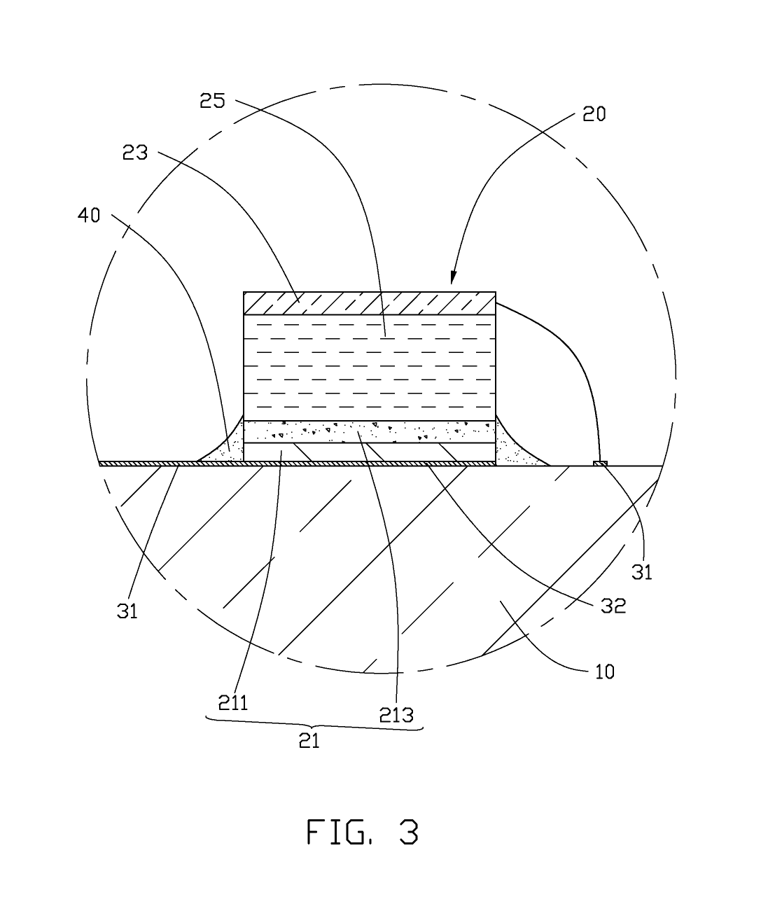

FIGS. 2 and 3 illustrate that each of the solar cell units 20 comprises a working electrode 21. Each of the working electrodes 21 comprises a conductive substrate 211 and a semiconductor layer 213 coated on and in direct contact with the conductive substrate 211. The conductive substrates 211 are secured to the flexible transparent substrate 10.

The conductive substrates 211 are made of an electro-conductive material. The electro-conductive material can be a metal or alloy, such as stainless steel, gold, silver, copper, platinum, aluminum, or any combination thereof.

The semiconductor layer 213 is porous and consists essentially of a metal oxide. The metal oxide can be, but is not limited to being, titanium dioxide (TiO₂), tin dioxide (SnO₂), or zinc oxide (ZnO), or any combination thereof. In the exemplary embodiment, the metal oxide is TiO₂.

In the exemplary embodiment, the solar cell units 20 are dye-sensitized solar cells (DSSCs). Each of the working electrodes 21 further comprise photosensitive dye (not shown) absorbed on the semiconductor layers 213.

A transparent and patterned electrode layer 30 is formed on the flexible transparent substrate 10 and is configured to electronically connected to anodes and cathodes of the solar cell units 20. The conductive substrates 211 are electronically connected to the electrode layer 30. The electrode layer 30 can transmit electricity created by the solar cell units 20. The electrode layer 30 is made of a transparent and electro-conductive material selected from a group consisting of indium tin oxide (ITO), indium zinc oxide (IZO), aluminum oxide doped zinc, gallium oxide doped zinc oxide, carbon nanotubes, and Mg(OH)₂—C. The electrode layer 30 can be formed by depositing a thin film of transparent and electro-conductive material on the surface of the flexible transparent substrate 10 having the solar cell units 20 and then patterning the film to have a desired shape. In the exemplary embodiment, the electrode layer 30 comprises a plurality of wire portions 31 and a plurality of contact portions 32 connected to the wire portions 31. Each of the contact portions 32 has a shape and a size substantially equal to that of the conductive substrates 211. Each of the conductive substrates 211 is in directly contact with one of the contact portions 32.

Each of the solar cell units 20 further comprises a transparent counter electrode 23 and an electrolyte 25 between the working electrode 20 and the transparent counter electrode 23. Each transparent counter electrode 23 is electronically connected to one of the contact portions 32. Sunlight can enter the solar cell units 20 through transparent counter electrode 23.

The solar cell units 20 have such a shape, size, thickness, and a distance between each other that do not degrade the flexibility of the flexible transparent substrate 10 or a light transmitting property of the solar cell 100. Examples of shapes of the solar cell units 20 comprise cylinder and prism such as cuboid. The conductive substrates 211 can have the same single shape or have multiple shapes. As shown in FIG. 1, the conductive substrates 211 have a cuboid shape in this embodiment. The conductive substrates 211 can have a cross-sectional area parallel to the flexible transparent substrate 10 in a range from about 0.01 cm² to about 400 cm². The conductive substrates 211 can have a thickness in a range from about 0.001 μm to about 10 mm.

Referring to FIG. 3, in one embodiment, the conductive substrates 211 are secured to the flexible transparent substrate 10 by an adhesive 40. The adhesive 40 can be electro-conductive adhesive containing metal particles such as silver particles. The adhesive 40 also can be a non-conductive adhesive, such as UV curable resin adhesive. If the adhesive 40 is a non-conductive adhesive, to ensure a direct contact between the conductive substrates 211 and the electrode layer 30, the adhesive 40 can be formed only on side surfaces of the conductive substrates 211, and not on a bottom surface which is in contact with the electrode layer 30, thereby ensuring a good conductivity between the conductive substrates 211 and the electrode layer 30. If the adhesive 40 is a transparent and electro-conductive adhesive, the adhesive 40 can also be positioned between the bottom surfaces of the conductive substrates 211 and the electrode layer 30.

A method for manufacturing the solar cell 100 according to an exemplary embodiment can comprise the following steps.

The plurality of solar cell units 20 are prepared. Preparing the solar cell units 20 comprises the following steps.

The conductive substrates 211 made of metal or alloy are provided.

A colloidal paste is prepared. The colloidal paste comprises said metal oxide, a solvent, and an organic binder. The colloidal paste can be prepared from a colloidal solution of nanoparticles of the metal oxide. The organic binder can be selected from long chain polymers such as ethyl cellulose, polyethylene glycol, or polyvinyl alcohol. The solvent can be selected from alcohols such as ethanol, propanol, or terpineol.

The colloidal paste is applied to a surface of each of the conductive substrates 211.

The conductive substrates 211 coated with the colloidal paste are heated to sinter the metal oxide, thereby creating the porous semiconductor layers 213 on the conductive substrates 211. Traditional sintering is typically carried out by thermal treatment at a temperature of 450° C. to 600° C. for a period of time of at least 30 minutes. In the exemplary embodiment, the conductive substrates 211 are heated to a temperature in a range from about 400° C. to about 500° C. Sintering ensures that the metal oxide particles adhere to each other thereby efficiently carrying current and that they adhere strongly to the conductive substrates. Sintering also ensures complete removal of the organic binder and solvent present in the colloidal paste thereby increasing a porosity of the semiconductor layer 213. During sintering of the metal oxide, the conductive substrates 211 are resistant to damage.

The flexible transparent substrate 10 having the transparent and patterned electrode layer 30 is provided. In one embodiment, the electrode layer 30 is formed by sputtering an ITO film on a surface of the flexible transparent substrate 10 and then etching the ITO film to have a desired pattern shape.

The solar cell units 20 are secured to the flexible transparent substrate 10, to be electronically connected to the contact portions 32 of the electrode layer 30 through the conductive substrates 211. In the exemplary embodiment, the conductive substrates 211 are secured to the flexible transparent substrate 10 by an adhesive.

The embodiments shown and described above are only examples. Many details are often found in the art such as the other features of a solar cell. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A flexible solar cell, comprising:
a flexible transparent substrate; and
a plurality of solar cell units attached to the flexible transparent substrate and space from each other, thereby defining light-transmitting areas on the flexible transparent substrate among the solar cell units, allowing light to transmit therethroug.

2. The flexible solar cell of claim 1, wherein each of the solar cell units comprises a working electrode; each of the working electrodes comprises a conductive substrate and a semiconductor layer coated on and in direct contact with the conductive substrate; the conductive substrates are secured to the flexible transparent substrate.

3. The flexible solar cell of claim 2, wherein the semiconductor layers consist essentially of a metal oxide.

4. The flexible solar cell of claim 3, wherein the metal oxide is one or more selected from the group consisting of titanium dioxide, tin dioxide, and zinc oxide.

5. The flexible solar cell of claim 2, wherein each of the working electrodes further comprises photosensitive dye absorbed on the semiconductor layers.

6. The flexible solar cell of claim 2, wherein the conductive substrates are secured to the flexible transparent substrate by adhesive.

7. The flexible solar cell of claim 2, further comprising a transparent and patterned electrode layer formed on the flexible transparent substrate, the conductive substrates are electronically connected to the transparent and patterned electrode layer.

8. The flexible solar cell of claim 7, wherein the transparent and patterned electrode layer is made of a transparent and electro-conductive material selected from a group consisting of indium tin oxide, indium zinc oxide, aluminum oxide doped zinc, gallium oxide doped zinc oxide, carbon nanotubes, and Mg(OH)₂—C.

9. The flexible solar cell of claim 7, wherein each of the solar cell units further comprises a transparent counter electrode and an electrolyte between the working electrode and the transparent counter electrode; the transparent counter electrodes are electronically connected to the transparent and patterned electrode layer.

10. The flexible solar cell of claim 2, wherein conductive substrates comprise metal or alloy.

11. The flexible solar cell of claim 1, wherein the flexible transparent substrate is made of plastic or glass.

12. A method for manufacturing a flexible solar cell, comprising:
preparing a plurality of solar cell units;
providing a flexible transparent substrate; and
securing the plurality of solar cell units to the flexible transparent substrate, space from each other, wherein the plurality of solar cell units thereby defining light-transmitting areas on the flexible transparent substrate among the solar cell units, allowing light to transmit therethroug.

13. The method of claim 12, wherein preparing the solar cell units comprises:
providing a plurality of conductive substrates;
preparing a colloidal paste comprising a metal oxide, a solvent, and an organic binder;
applying the colloidal paste to a surface of each of the conductive substrates; and
heating the conductive substrates coated with the colloidal paste to sinter the metal oxide, thereby removing the solvent and the organic binder and creating a semiconductor layer on each of the conductive substrates.

14. The method of claim 13, wherein the conductive substrates are made of metal or alloy.

15. The method of claim 13, wherein the flexible transparent substrate has a transparent and patterned electrode layer formed thereon, the conductive substrates are electronically connected to the transparent and patterned electrode layer.

16. The method of claim 15, wherein the transparent and patterned electrode layer is made of a transparent and electro-conductive material selected from a group consisting of indium tin oxide, indium zinc oxide, aluminum oxide doped zinc, gallium oxide doped zinc oxide, carbon nanotubes, and Mg(OH)₂—C.

17. The method of claim 13, wherein the metal oxide is one or more selected from the group consisting of titanium dioxide, tin dioxide, and zinc oxide.

18. The method of claim 12, wherein the solar cell units are secured to the flexible transparent substrate by an adhesive.

19. The method of claim 12, wherein the solar cell units are arranged in an array.
